(19) United States
(12) Patent Application Publication
(10) Pub. No.: US 2003/0154071 A1
(43) Pub. Date: Aug. 14, 2003

(54) Process for the document management and computer-assisted translation of documents utilizing document corpora constructed by intelligent agents

(76) Inventor: Gregory M. Shreve, Kent, OH (US)

Correspondence Address: RENNER, KENNER, GREIVE, BOBAK, TAYLOR & WEBER, FOURTH FLOOR, FIRST NATIONAL TOWER, AKRON, OH, 44308, US

(21) Appl. No.: 10/073,516

(22) Filed: Feb. 11, 2002

(51) Int. Cl. G06F 17/27; G06F 15/00

(52) U.S. Cl. 704/9; 715/500

(57) ABSTRACT

A method of document management utilizing document corpora including gathering a source corpus of documents in electronic form, modeling the source corpus in terms of document and domain structure information to identify corpus enhancement parameters, using a metalanguage to electronically tag the source corpus, programming the corpus enhancement parameters into an intelligent agent, and using the intelligent agent to search external repositories to find similar terms and structures, and return them to the source corpora, whereby the source corpus is enhanced to form a unicorpus.

### TECHNICAL FIELD

The present invention relates to processes used in document management, computer-assisted translation, and software localization in general, and, in particular, to methods of constructing and exploiting artificially constructed multilingual document corpora to improve the efficacy of computer-assisted translation, including software localization.

### BACKGROUND OF THE INVENTION

The early history of the language industry was plagued with technical issues, such as those surrounding computer display of non-Western writing systems, with their character set and directionality problems. With the advent of new standardized technologies, such as e.g., the introduction of Unicode solutions, these problems are on the way to resolution. Initial efforts concentrated on the “simple” one-off translation of user interfaces and software documentation, an approach that quickly gave way to a greater focus on internationalization, which involves the creation of software (and other) products that are culture-neutral from the outset and that separate culture and language-neutral software kernels from independent resource files. The resource files contain various types of user interfaces and documentation. Over time, attention has turned to strategies and tools for making the localization of software easier, faster, less expensive and less disruptive to the software or website development process.

The localization/internationalization/translation business services sector or “language industry” today has evolved primarily as a result of the global expansion of the personal computer software market and the increasing use of the internet as a global marketing and customer service tool—a process which will be referred to as globalization. Globalization has created a need for the fast and accurate translation of software, web sites and product documentation into locale-specific versions.

Today's burgeoning localization industry is focused on developing software techniques for isolating language/culture content along with tools for manipulating the

Today's burgeoning localization industry is focused on developing software techniques for isolating language/culture content along with tools for manipulating the isolated content (localization tools), with constant attention paid to the importance of content reuse or leveraging. Leveraging is the ability to re-use previously written or translated materials, and, ultimately, is used to reduce costs and save time by reducing the need for new expensive authoring or translation effort. In this context, Website internationalization and localization poses special problems, as does constantly upgraded software, in that the “one-off” model of the early days has given way to a continuous, never-ending process that requires constant feedback within the document and information development chain.

Presently, the globalization effort is made up of an internationalization component that has to be done once and a localization component that must be performed repeatedly. Localization is a process of preparing locale-specific versions of a product and includes the translation of textual material into the language and textual conventions of the target locale and the adaptation of non-textual materials and delivery mechanisms to take into account the cultural requirements of that locale. Localization is currently one of the fastest-growing sectors of the international economy, with the global market estimates at $12 billion annually. Localization vendors provide critical international business services such as web-page translation and software localization for multilingual versions of software packages.

Internationalization, on the other hand, is an engineering process whose objective is optimizing the design of products so that they can more easily be adapted for delivery in different languages and in locales with different cultural requirements. Internationalization is a precursor to localization and its purpose is both to lower the effort and cost of localization, and to increase the speed and accuracy with which localization can be accomplished. In an age where the fast, simultaneous release of multilingual documentation, web pages, or software is a corporate objective, such strategies are indispensable. As sub-processes of the broader process of globalization, localization and internationalization have been considered in view of the language industry's efforts to reduce costs and increase profit margins.

Because translation and localization are labor-intensive activities, profit margins have depended primarily on the application of technology (primarily in the form of translation memories and localization tools) and business processes to reduce the human cost of translation and improve translator quality and productivity. Cost reduction and productivity enhancement has been achieved primarily by, (1) the introduction of translation memories and terminology managers to reuse previous translations, (2) workflow control to track translated and localized material to provide version control, and (3) quality assurance processes focusing on terminology control and stylistic consistency.

Translation memories and terminology managers are special databases in which previous translations are stored to reduce the ratio of “new” sentences and technical terms to previously translated sentences and technical terms. These two technologies allow the use of previously written or translated content (leveraging). “Technical terms” refer, in shorthand form, to specialized terms that may be industry specific, such as, business, scientific, or legal terminology. Re-use of previous translations works as a cost-saving approach because the “document collection” of most organizations grows incrementally by adding limited amounts of new linguistic material to larger bodies of existing linguistic material.

There is a limit to the cost reductions and increased profits that can be achieved using translation re-use, workflow control and quality assurance methods. The limit exists because the source corpus or original body of material to be translated or localized has not been exploited to its full extent. Methods of leveraging the huge numbers of specialized and foreign language documents that exist in online repositories, digital libraries and the Internet have not previously been developed in the art. In effect, those in the art have not adopted an internationalization strategy that uses source corpora and online document corpora as part of an internationalization strategy.

The current focus within the language art is on increasing the level of automation (e.g., using translation memories to enable and automate re-use, and workflow control systems to shorten delivery times), to lower costs and increase profits. The current process also assumes that more complete automation is a key to more effective internationalization.

In that method (FIG. 1), terminology databases and translation memories used by translators at computer-assisted translation workstations must be populated by the actions of human translators. As a human translator solves a terminological or translation problem, he or she creates a record of that solution and stores it in the terminology database and translation memory. Over time, as other problems are solved, the terminology database and translation memory is populated with potential translations for technical terms that are often encountered in specialized translation and software localization. Thus, while there is an accumulation of terminological data over time, there is a time lag between the advent of any given translation project and the point at which a terminology database and translation memory for the project reaches an optimal useful size and scope. There is a concomitant restriction in the scope of the databases as their value is significantly dependent on the number and quality of the documents researched during its construction.

Current business policy in the language industry dictates that localization/translation vendors retain and aggregate the terminology databases and translation memories accumulated by their translator/localizers. As a translation company continues to populate its database in the domains in which it translates, the time lag declines for any given domain and the range of coverage increases. However, as new domains are added to the translation commissions accepted by a vendor, the lag/scope problem will re-occur.

### SUMMARY OF INVENTION

In light of the foregoing, one object of the present invention is constructing heuristic models of the contents (domain model) and document types and structures (document structure model) in a corpus of documents used in an organization (intranet-bounded corpus); using the models derived from the analysis of the above-mentioned corpus to derive parameters for the operation of intelligent agents over the Internet or other document repositories; enhancing and expanding the original or source corpus of documents by adding selected documents using intelligent document collection and analysis agents operating under the direction of the parameters derived from the heuristic models.

Another object is analyzing, using statistical and natural language processing methods, the artificially enhanced corpus or unicorpus for the purpose of discovering objects of significant utility for the localization and computer-assisted translation or authoring of specialized documentation (patents, scientific journal articles, medical reports, web pages, help files, software interfaces, presentations, tutorials and the like); tagging the unicorpus, such as by using the extensible markup language (XML), so as to allow for the identification, description and retrieval of useful objects, which include but are not limited to terminology lists, elements of terminology records, thesaurus and concept relationships, text-relevant collocations, standard phrases, boilerplate language, and recurrent text segments or textual superstructures (document templates) diagnostic of particular textual forms.

Still another object is replicating the original (monolingual) corpus multilingually (multilingual corpus cloning) so as to allow for the cross-linguistic alignment of terminology lists, collocations, phrases, sentences and textual segments and superstructures; offering the artificially-enhanced multilingual corpus thus created as an XML repository resource for consumers and vendors of translation and localization services, allowing them to pre-populate the terminology management and translation memory management components of their computer-assisted translation workstations, thereby saving them significant cost and effort.

Yet another object is linking all the unicorpora created for the purposes described above as a unified set of communicating resources using a peer-to-peer resource-sharing architecture, thus building a network of artificial corpora containing a significantly larger set of authoring, translation and localization resources for consumers and vendors of documentation, localization and translation services to employ.

In view of at least one of the foregoing objects, the present invention generally provides a method of document management utilizing document corpora including gathering a source corpus of documents in electronic form, modeling the source corpus in terms of document and domain structure information to identify corpus enhancement parameters, using a metalanguage to electronically tag the source corpus, programming the corpus enhancement parameters into an intelligent agent, and using the intelligent agent to search external repositories to find similar terms and structures, and return them to the source corpora, whereby the source corpus is enhanced to form a unicorpus.

The present invention further provides a global documentation method including modeling a source corpus to determine search parameters, providing the search parameters to an intelligent agent, enhancing the source corpus by accessing resources outside of the source corpus with the intelligent agent, where the intelligent tags the modeled source corpus and retrieves resources according to the search parameters to create a first unicorpus of tagged documents, replicating the first unicorpus in at least one other language to form a second unicorpus, and selectively mining at least one unicorpus to perform a selected task.

The present invention further provides a document management method including constructing models of a source corpus of documents, deriving parameters from the models for the operation of an intelligent agent over at least one external document repository, enhancing the source corpus of documents by adding selected documents retrieved by the intelligent agent to form an artificially enhanced corpus.

The present invention further provides a document management system operating according to a business method including providing document management services including translation and authoring services over a global information network to a customer, where the customer has a source corpus of documents to be managed, accessing the source corpus with an intelligent agent to analyze the source corpus, identify selected objects within the source corpus, and tag the selected objects with a metatag, wherein the analysis results in the generation of document parameters programmed into the intelligent agent for searching of external document repositories, wherein the intelligent agent uses the parameters to identify and tag objects of interest in the external document repositories and selectively retrieve the objects to enhance the source corpus, and tracking rights in the retrieved objects to determine a royalty payable to an owner of the rights.

The present invention further provides a document management system, in which a document manager is linked to a plurality of unicorpora via a peer-to-peer network, the document management system including a method of providing document management services including authoring and translation including receiving a document management request from a unicorpora in the network, programming an intelligent agent with a set of parameters responsive to the request, deploying the intelligent agent to search unicorpora in the peer-to-peer network to identify objects responsive to the request, and transmitting the objects to the requesting unicorpus by way of the peer-to-peer network.

The present invention further provides an intelligent agent in a document management method including a program containing parameters derived from heuristic models of a source corpus, wherein the parameters are implemented in the program to locate and retrieve documents from external document repositories.

The present invention further provides an intelligent agent used in a document management method comprising a program including a tagging subroutine operating under parameters, the parameters causing the program to search a corporus and directing the tagging subroutine to tag language objects within the corporus.

The present invention further provides an intelligent agent for searching external corpora including a processor having search parameters programed to search external corpora according to the parameters for content, tag the content identified in the search, a selectively retrieve the content.

The present invention further provides computer readable media tangibly embodying a program of instructions executable by a computer to perform an enhancing of a source corpus in a document management system including receiving electronic signals representing parameters including document structure and document domain information regarding the source corpus, searching external document repositories according to the parameters to identify and tag document domain and structure information in the external document repositories according to the parameters, and reporting the tagged information for selective retrieval of the tagged information.

The present invention further provides computer readable media tangibly embodying a program of instructions executable by a computer to perform a method of managing documents in a document management system including constructing heuristic models including a domain model and a document structure model in a source corpus of documents, using the heuristic models to derive parameters for the operation of an intelligent agent over at least one external document repository, enhancing the source corpus of documents by adding selected documents using the intelligent agent operating under the direction of parameters derived from the heuristic models to form an artificially enhanced corpus.

The present invention further provides a document management system, in which a source corpus is enhanced by the use of an intelligent agent to create an artificially enhanced corpus by a method including receiving electronic signals for representing a document from the intelligent agent, the document including domain and structure information, performing heuristic modeling of the source corpora and the received document, and sending electronic signals representing search parameters derived from the modeling to the intelligent agent requesting another document according to the search parameter.

### BRIEF DESCRIPTION OF THE DRAWINGS

FIG. 1 is an overview of a prior art computer-assisted localization and translation, where the translator/localizer is the focus of the time-intensive research and data collection activity required to populate the translation memory and terminology modules of translation workstations;

FIG. 2 shows an overview of a global documentation method according to the present invention that makes the localization/translation process more effective by automating significant portions of the translator/localizer's work In particular, the global documentation method pre-populates the translation memory and terminology modules of translation workstations as well as identifying and providing access to other objects of utility in computer-assisted authoring and translation;

FIG. 3 shows an overview of processes incorporated in the global documentation system;

FIG. 4 is an overview schematically depicting building the domain and document structure models according to the present invention;

FIG. 5 is a flow diagram depicting steps included in building the domain model;

FIG. 6 is an overview of concept objects that aggregate term synonyms and multilingual equivalents around a conceptual core;

FIG. 7 is a flow diagram depicting steps included in building the document structure model;

FIG. 8 is an overview depicting documents retrieved from the Internet or other document repositories being identified, analyzed and tagged;

FIG. 9 is an overview depicting use of identification algorithms and tagging processes to discover and describe objects useful in localization and authoring;

FIG. 10 is a view of a multilingual corpus replication or “corpus cloning” process that discovers possible multilingual equivalents of objects in the original monolingual unicorpus;

FIG. 11 is a view of the objects useful in localization and authoring that identification algorithms and tagging processes discover and describe;

FIG. 12 is a flow diagram depicting arrangement of terms by term parsing algorithms into concept networks or systems;

FIG. 13 is an overview of an enhanced corpora functioning as the basis for assembling culturally compliant documents using a client-side socio-cultural style-sheet approach; and

FIG. 14 is an overview depicting the linking of an enhanced corpora in a peer-to-peer network creating a network of authoring and translation resources.

### PREFERRED EMBODIMENT CARRYING OUT THE INVENTION

A global documentation method is generally indicated by the numeral 10 in the figures and described herein. In the course of this description heading numbers have been used to aid the reader in following the discussion of the global documentation method 10. These are provided for the reader's convenience and are not intended to be limiting in terms of the dependency or order of the described subjects, their ability to interrelate with each other, or in terms of the scope of the material described therein. It will be understood that the global documentation method described herein is to be implemented on a computer system and may be programmed into various computer readable media including portable media such as diskettes, memory sticks, or CD or DVD technology or fixed medium such as the ram, rom., or hard drive of a computer.

The present invention generally relates to a global documentation method, which significantly improves the speed, efficiency and accuracy of computer-assisted authoring, translation and localization. This method takes a source corpus, or original body of material to be translated or localized, and transforms the original source corpus to create a specifically constructed pool of documents or artificial source corpus. That corpus is then used as the basis for automatically extracting objects that can be used in a new generation of authoring or translation workstations.

The global documentation method, to be described below in detail, analyzes an organization's naturally occurring collection of documents and then constructs statistical and heuristic models of its content and range of document types. These two models reflect the range of subject areas and the kinds of document types of greatest import and utility to the organization. The model is used to provide parameters to an intelligent agent so that it may acquire new documents in a specific, targeted manner from the Internet and/or other document repositories outside the original boundaries of the organization's corpus.

The new corpus thus constructed is a significant enhancement over the original corpus, as it can be assumed to contain a more complete set of the prototypical instances of the specialized vocabulary, semantic relations, linguistic usages, phraseology, and document formats and document types that are of greatest import and utility to the organization. This artificially enhanced corpus (hereafter referred to as a unified corpus or unicorpus) can be taken to more accurately reflect existing “best practices” in the written communications of the linguistic community to which the organization belongs.

The artificially enhanced corpus is analyzed and tagged. Tagging allows for the description and later retrieval of linguistic and textual objects discovered within the artificially enhanced corpus. These objects include but are not limited to terminology lists, elements of terminology records, thesaurus or concept relationships, text-relevant collocations, standard phrases, boilerplate language, and recurrent text segments or textual superstructures diagnostic of particular textual forms.

The unicorpus may be replicated multilingually (multilingual corpus cloning) so as to allow for the cross-linguistic alignment of terminology lists, collocations, phrases, sentences and textual segments and superstructures. The added multilingual resources are themselves analyzed and tagged so as to allow not only for the cross-linguistic alignment of linguistic items (translation pairs), but for the purpose of providing information on culturally-bound preferences with respect to the structure and format of documents (cultural document profiles).

The multilingual unicorpus thus created is an enhanced repository or database, a resource for consumers and vendors of translation and localization services. The repository allows consumers and vendors of translation or localization services to pre-populate the terminology management and translation memory management components of their computer-assisted translation workstations, thereby saving them significant cost and effort. In addition to pre-populating these data modules, the use of artificially enhanced corpora such as a unicorpus also allows other objects of utility to be identified and used in computer-assisted translation. If the unicorpus is not multilingually replicated, it may still serve useful purposes in the context of workstations for computer-assisted authoring of technical or other specialized documents.

All of the corpora created for the purposes described above can be linked as a unified set of communicating resources using a peer-to-peer resource-sharing architecture, thus building a network of artificial corpora containing a significantly larger set of translation and localization resources for consumers and vendors of localization and translation services to employ.

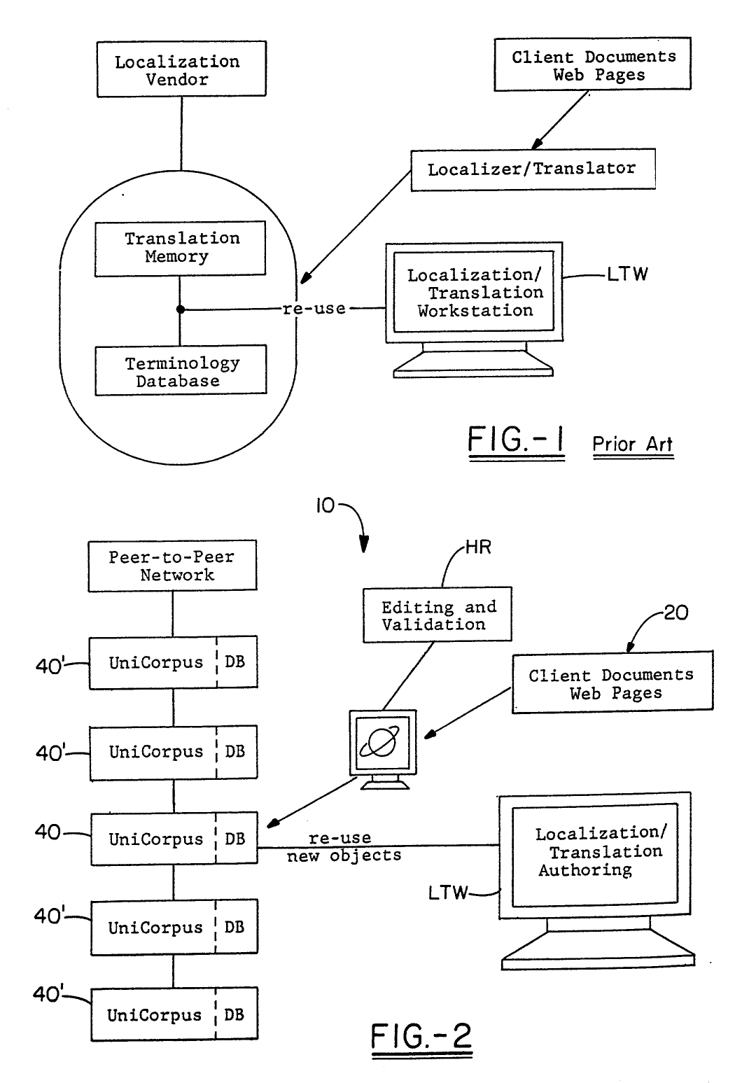

The following description will bear out more details of the document management system and its intent in global documentation method. The description begins with a discussion of the customer's source corpus and the steps used to analyze and enhance the source corpus to form a unicorpus of tagged documents useful in generating search parameters that may be used to add to the original body of documents or perform specific tasks such as authoring or translation. The discussion will also describe the analytic methods used to identify objects including the document content and structure in an automated fashion. Further details will be provided in regard to assembling the simple objects found during a search into more complex composite objects to identify the relations between objects within various document repositories. Following the description of the source corpus, and its enhancement into a unicorpus, a description continues with the use of metatags in the formation of search parameters to perform tasks such as authoring or translation and, finally, the use of the document management system in various networks including a peer-to-peer system. An example overview of the entire process is depicted in FIG. 2 of the drawings.

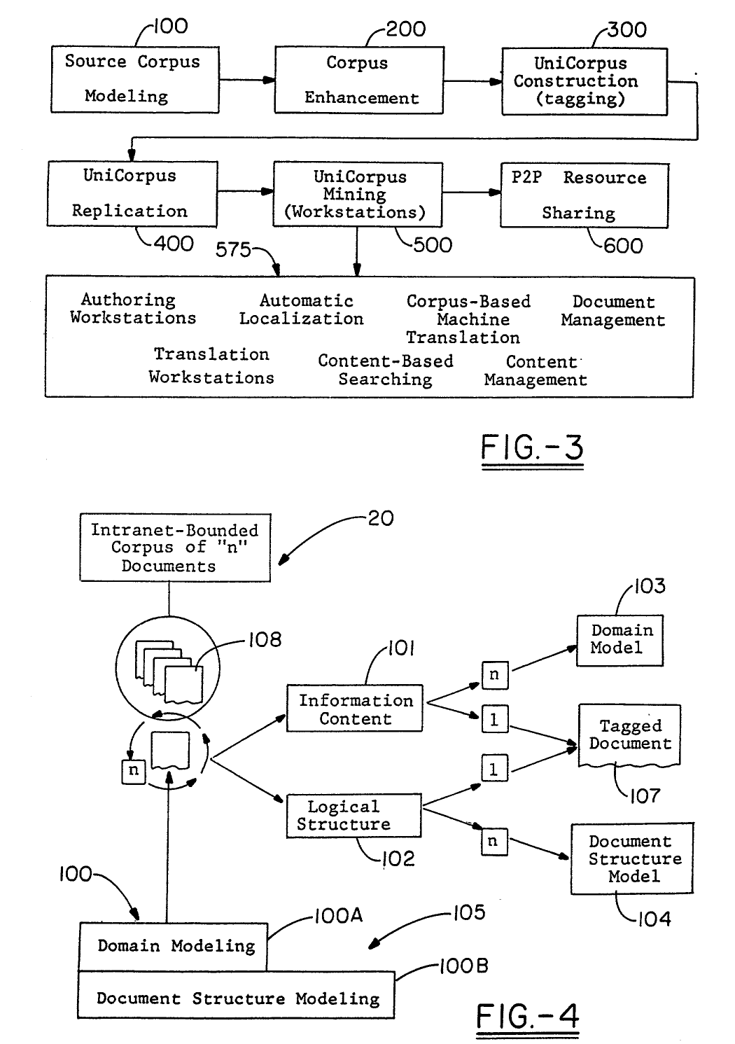

In general, the global documentation method 10 (FIG. 2), to be described below in detail, includes a process, collectively referred to as Intelligent Corpus Building, that analyzes an organization's naturally occurring collection of documents, referred to as the intranet bound or source corpus 20 (FIG. 4), and then constructs statistical and heuristic models of its content 101 and range of document types 102 in a process referred to as source corpus modeling, generally indicated by the numeral 100 in FIGS. 3, 4 and 5. These two models reflect the range of subject areas and the kinds of document types of greatest import and utility to the organization. The model is used to provide parameters to an intelligent agent IA so that it may acquire new documents in a specific, targeted manner from the Internet and/or other document repositories 30 outside the original boundaries of the organization's source corpus 20.

The new corpus thus constructed is a significant enhancement over the original source corpus 20, as it contains a more complete set of the prototypical instances of the specialized vocabulary, semantic relations, linguistic usages, phraseology, and document formats and document types that are of greatest import and utility to the organization. This artificially enhanced corpus, generally referred to as a unified corpus or unicorpus 40, can be taken to more accurately reflect existing “best practices” in the written communications of the linguistic community to which the organization belongs.

The unified corpus 40 is analyzed and tagged in a process referred to as unicorpus construction 300. Tagging allows for the description and later retrieval of linguistic and textual objects 50 discovered within the unified corpus 40. These objects 50 include, but are not limited to, terminology lists, elements of terminology records, thesaurus or concept relationships, text-relevant collocations, standard phrases, boilerplate language, and recurrent text segments or textual superstructures diagnostic of particular textual forms.

In a process referred to herein as unicorpus replication 400, the unicorpus 40 may be replicated multilingually (multilingual corpus cloning) so as to allow for the cross-linguistic alignment of terminology lists, collocations, phrases, sentences and textual segments and superstructures. The added multilingual resources are themselves analyzed and tagged so as to allow not only for the cross-linguistic alignment of linguistic items (translation pairs), but for the purpose of providing information on culturally-bound preferences with respect to the structure and format of documents (cultural document profiles).

The multilingual unicorpus 60 thus created is an enhanced repository or database, a resource for consumers and vendors of translation and localization services. The repository 60 allows consumers and vendors of translation or localization services to pre-populate the terminology management and translation memory management components of their computer-assisted translation workstations, thereby saving them significant cost and effort. In addition to pre-populating these data modules, the use of artificially enhanced corpora such as a unicorpus 40 also allows other objects of utility to be identified and used in computer-assisted translation. If the unicorpus 40 is not multilingually replicated, it may still serve useful purposes in the context of workstations for computer-assisted authoring of technical or other specialized documents as during unicorpus mining 500.

All of the corpora created for the purposes described above can be linked as a unified set of communicating resources using a peer-to-peer resource-sharing architecture 600, thus building a network of artificial corpora containing a significantly larger set of translation and localization resources for consumers and vendors of localization and translation services to employ.

1.1 Intelligent Corpus-Building

Intelligent corpus building is a process employing intelligent agents IA such as web spiders to create a specially constructed document corpus. Intelligent corpus-building within the scope of this invention assumes that an source corpus 20 represents a “natural model” of the text world of an entity, such as a corporation, law firm, government agency, or university. This natural model might include a large, but finite, set of exemplars of the document types and subject domains of greatest interest and concern to the corpus-owning entity. Analysis of this natural model—which is intrinsic and implicit—can yield a more explicit model of the document types and subject domains contained within the corpus 20 that can be used to artificially enhance the natural model according to desired parameters.

1.1.1 Modeling the Intranet-Bounded Corpus

Corpus model-building involves the application of a set of specific parsers or parsing 105 to the source corpus 20 for the purpose of model-building. The models to be constructed are a corpus document domain model 103 and a corpus document structure model 104. The parsers allow the intelligent agent IA to recognize, classify, organize and tag text strings. Parsing 105 is understood in the context of this invention to consist of a set of analytical routines 106 to identify, by statistical, natural language processing or hybrid means, discrete text-linguistic structures in unstructured text data and to tag 107 the structures thus identified so as to allow them to be subsequently retrieved, displayed or organized. In the context of this invention, tagging is the assignment of an appropriate tag and one or more tag attributes from a metadata schema to the structures identified in the parsed data. No proprietary metadata schemas are implied by the methods described here, though proprietary schemas may be used when existing standardized or recommended schemas do not exist (FIG. 4).

1.1.2 Corpus Domain Model

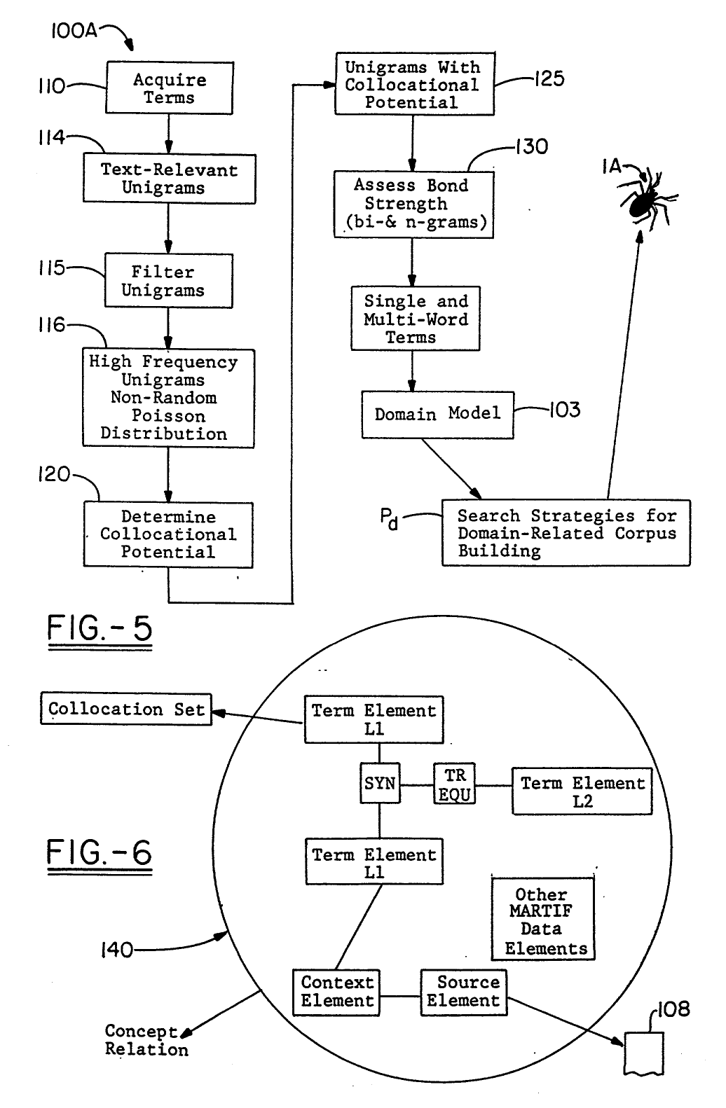

The corpus domain model assumes that the textual-linguistic structures of the documents encode content data 101, 102. A model of the significant conceptual contents of documents 108 can be generated by capturing the distribution of terms (specialized vocabulary) and collocations contained in a document and, more generally, within the source corpus 20. We define collocation as a recurrent pattern of words in a corpus. The distribution of terms and collocations across the source corpus 20 is taken to be a linguistic representation of the concept networks or ontologies (FIG. 5) underlying the document content 101, 102. The domain model 103 includes a hypothesis of the range and intersection of the domains represented by the vocabulary as well as hypotheses regarding the diagnostic criteria for identifying and organizing domains and their constituent concepts into semantic networks. The underlying process for determining the special vocabulary used in the corpus domain model is term and collocation parsing (FIG. 6).

Term parsing 110, 115 is a process of uncovering the specialized vocabulary of a particular subject domain. Terms may be single word terms or multiple word terms. The first step in term extraction is to find words that can be term candidates, a process called term acquisition 110. This process 110 depends on exploiting the statistical and/or grammatical properties of words most likely to be terms. Terms are likely to be high frequency content words 114 with a non-random Poisson distribution over a corpus. In the current invention, single-word term candidates are derived by a process 115 that involves (a) tagging the text for part-of-speech, (b) generating a list of all the words in a document, (c) removing function words and other any non-desired words from the word list based on part-of-speech and/or stop list, (d) lemmatizing the remaining content words using morphological analysis to avoid the under-representation of a term candidate due to the existence of inflected forms, (e) retaining as candidate terms those content words meeting a threshold requirement e.g., those above a cut-off point below which words are likely not to be textually relevant. The output of this initial term extraction process is a list of unigrams considered to be text-relevant 116.

As a term parsing proceeds over the documents in the corpus, the distribution of the candidate term over the corpus can be calculated. Those content words showing a random distribution over the corpus 20 can be removed from the term candidate list and those that show non-random distribution 116 can be retained (115).

Of course, not all terms are single words. At the end of the process listed above we have a list of textually relevant unigrams that may be term candidates 114, 116. Some of these candidate terms 114, 116 may appear in the corpus primarily by themselves, others as partners of another unigram e.g., as bigram. We are not interested in all statistically relevant bigrams (e.g., in those composed of a function word with a content word), but in bigrams composed of two content words. The next step is to determine which unigrams appear primarily alone and which unigrams have collocational potential 120.

Collocational potential can be determined (120) by examining the statistical distribution of the left and right adjacent context of the unigrams in the term candidate list. If a unigram appears in a text n times and appears in combination with x other unigrams to its right or left, and x approaches n in value, we can assume there is no preference for particular partners. On the other hand, if a unigram combines regularly with only a few partners to its right or left, e.g., it appears n times but with only x other unigrams to its left or right, where x is significantly less than n, we can assume that there is a preference for a small range of particular partners. This latter group would comprise a set of unigrams with collocational potential (125). Some, but not all, of these will be parts of multiple word terms.

The list of unigrams with collocational potential generated in the step 120 above can now be assessed in terms of bond strength(130). Each bigram in which one of the unigrams with high collocational potential appears is assessed to find the strength of the bond between the two. The bond strength is a function of the number of times a word occurs in a given bigram compared to how often the word occurs as a unigram. The assumption is that a unigram has a high bond strength with another word if the bigram frequency accounts for a major part of the frequency of the unigram. By looking for bigrams that exhibit high bond strength, the agent IA can isolate candidates for multiple word terms.

Of course, not all terms are two-word terms. We can use a procedure to expand the textually relevant bigrams determined above into n-grams by examining the words in their immediate context. Our collocation parser 120 uses a statistical procedure described by Smadja, F., “How to Compile a Bilingual Collocational Lexicon Automatically,” AAAI-92 Workshop on Statistically Based NLP Techniques, July 1992, incorporated herein by reference, to identify and extract collocates. A primary objective of identifying collocations is to discover multiple-word terms, but the technique may also be used to identify stereotypical or “boilerplate” language and word associations.

Once all single and multiple word terms have been determined, then the terms are arranged into concept systems. Concept systems are semantic networks that indicate the relationships between terms. For computer-assisted translation and authoring purposes, concept systems may be used as a mechanism for aggregating multilingual equivalents of terms and monolingual terms that are synonyms into a common concept object 140. Here the operative principle is that linguistic labels that refer to the same concept are aggregated into a concept object (FIG. 6).

Discrete concept objects are then linked in semantic networks that indicate hierarchic, pragmatic or other semantic relationships between them (FIG. 5). The automatic generation of semantic networks can be accomplished by a number of mechanisms, all of which may be utilized by the global documentation method as necessary and appropriate, for example:

Existing ontologies or ontology libraries may be used to indicate important semantic relationships. The approach begins by identifying a small number of key domain terms (called seeds) and mapping these terms to existing ontologies.

Hierarchical relationships may also be determined by identifying terms that co-occur in definitive contexts. These are contexts that posses a so-called “genus-differentia” structure that specifies the hierarchical relationships.

A variety of statistical techniques that compute coefficients of “relatedness” between terms using statistical co-occurrence algorithms (e.g., cosine, Jaccard, Dice similarity functions) or cluster analysis to group terms of similar meanings may also be used to determine object relationships. Co-occurrence data can be used, for instance, for generating related term, or synonymy relations.

Hybrid methods combine the previously described methods. Such methods might employ existing ontologies (object filtering), co-occurrence analysis and neural networks (associative retrieval) to generate relationships between concept objects. As previously described the results of domain modeling may be used to create search strategies programmed into an intelligent agent IA that performs searches outside of the source corpus.

1.1.3 Corpus Document Structure Model

The corpus document structure model 104 assumes that the textual-linguistic entities within the source corpus 20 encode information about document logical structure and physical layout 102 (FIG. 10). Document logical structure 102 reflects cultural norms of document organization and their logical relationships and sequence. Logical structure 102 can be generally decomposed into logical elements such as chapters, sections, subsections, paragraphs, and so on. Physical layout focuses on characteristics of the display medium, e.g., pages, lines, characters, margins, indentation, fonts, etc. The relationships of logical structure to physical layout are also culturally determined. The range of options for physical layout will vary, of course, by medium.

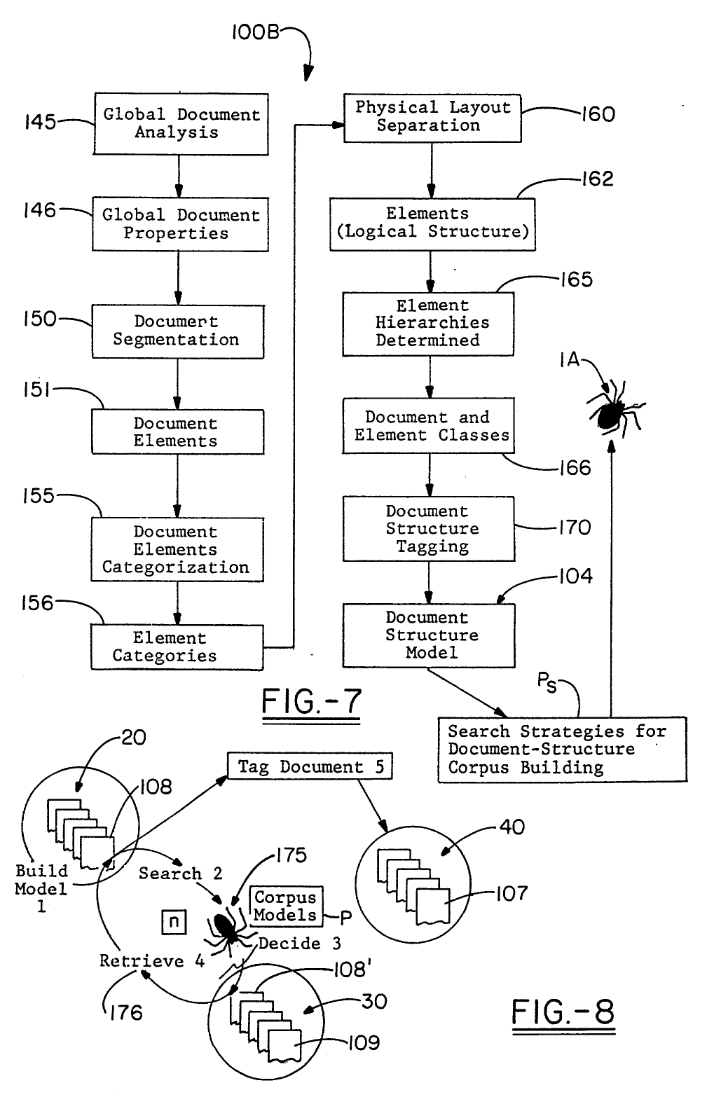

Documents have internal textual-linguistic semantic structures that are associated with function and purpose (transaction type). Specific patterns of these internal structures (recurrent collocations or phrases, recurrent sentence sequences, patterns of headings and subheadings, diagnostic lexemes) are taken to be diagnostic of particular document types, e.g., technical reports, web pages, memoranda, patents, contracts, and so on. A source corpus 20 is presumed to contain an intrinsic or natural model of the distribution of document types of greatest interest and concern to the corpus-owning organization. The corpus document structure model 104 is a hypothesis of the range of document classes in the corpus 20 and hypotheses regarding the diagnostic criteria for classifying the documents 108 found in the corpus 20 as to type. The document structure model 104 is a specification of the logical structural entities 102 that occur within the source corpus 20, their hierarchical relationships and associated physical layout (FIG. 7).

The corpus document structure model 104 has a granularity that ranges from the micro-structural level (diagnostic criteria that reside at the collocation, phrase and sentence level) to the macro-structural level (diagnostic criteria applying to larger segments of the documents, e.g., paragraphs or groups of paragraphs) to the super-structural level (titles, headings and subheadings). These structures 102 at all levels can be determined computationally and described via a metadata scheme using a meta language or markup language such as XML. In cases where markup of such documents already exists (e.g., application of styles, HTML documents) a mapping of existing markup to the metadata scheme employed within the scope of this invention would be employed.

Computational methods for determining document structure patterns are dependent on the encoding and storage format of the documents to be analyzed. A significant number of extant systems for document structure identification begin with corpora 20 of scanned images (such as those in many document management systems) and attempt to statistically model document structure by image analysis. These documents and others that do not use scanned image corpora but parse documents in their native formats (PDF, RTF) can be incorporated in the process described in this invention.

When discovered during parsing and analysis, constituent elements (titles, headings, sections, subheadings, paragraphs, list items) will be tagged and their corresponding physical characteristics, where present, extracted and stored. The general steps involved in developing a logical structure description for a document or document image are:

Global document analysis 145 including document length, readability, terminological density, language and any other global document properties 146.

Segmentation 150 of the document into discrete document segments or elements 151 (image blocks or paragraphs). The number of segments are stored as part of global document properties 146.

Categorization 155 of document constituents according to common characteristics, such as size of a segment 151, relative position in document, relative relationship to elements above and below, presence of diagnostic lexemes, presence of proper names, presence of diagnostic collocations, presence of semantically significant stylistic information to produce element categories 156.

Separation 160 of physical layout information from logical structure properties with preservation of physical layout information for each constituent.

Logical grouping 162 of document constituents into classes, where feasible.

Organization 165 of constituents into hierarchy 166 where such a hierarchy is determinable using a heuristic which may be based on properties such as differentials in font size, bulleting, enumeration, paragraph length and other heuristics.

Determination of scanning 135A (reading) order of the document constituents.

Tagging 170 of document constituents using metadata elements from a metadata scheme for logical document structure representation. To the extent that metadata schema already exist for representing document specific document structures they will be employed.

When analysis is complete, the logical description of a document 108 can be extracted from the document 108 and presented as a XML tree structure (with the entire document 108 as the root node and individual constituents as leaf nodes). Any individual constituent element 151, tagged with an XML tag, can be extracted and compared to similar constituents in other documents 108. Constituents from many documents can be compared and recurrent patterns recorded, creating the possibility of developing prototypical or classificatory properties for constituent and document classes.

1.1.4 Internet/Extra-net Corpus-Building: Enhancing the Corpus

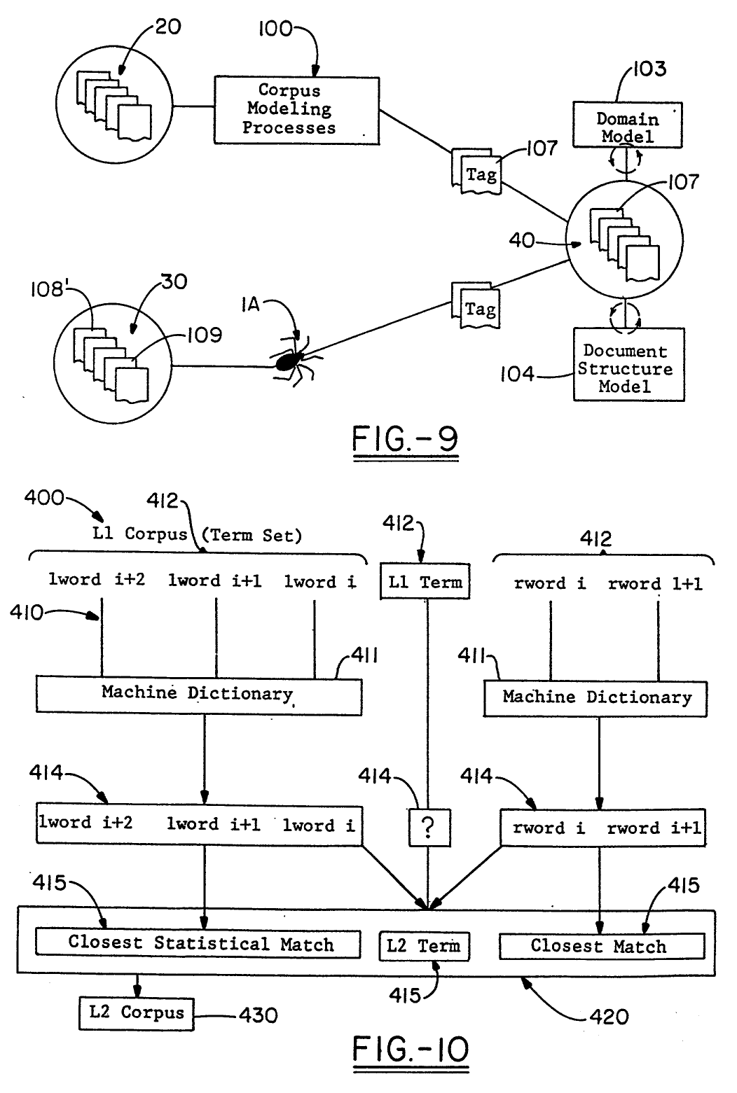

The corpus domain model 103 and corpus document structure model 104 may yield explicit sets of search strategies and diagnostic criteria or domain and structure parameters respectively indicated by the letters P_{d}, Pₛ or generally indicated by the letter P that can be provided to an intelligent web agent IA (e.g., spider). With these parameters P, the web agent IA can perform broader searches 175 of other document repositories 30 including wider intranets or the Internet to more intelligently retrieve 176 further exemplars of document types and document domains identified within the smaller, natural set above. Such a tactic can have the result of enhancing or enriching the original corpus 147 and improving subsequent incremental modeling of the corpus (FIGS. 8 and 9).

In this stage 200, FIG. 8, of intelligent corpus building an intelligent agent IA is deployed on wider intranets or the Internet to analyze 175 and retrieve documents 176 that meet the modeled criteria P discovered earlier. This approach is similar to that of automatic classification in information retrieval research that involves teaching a system to recognize documents belonging to particular classification groups by seeding the system with a set of document examples that belong to certain classifications. The system can then build class representatives utilizing the common features known to characterize a particular classification group. As a result, the enhanced corpus 40 becomes a repository of tagged documents 107.

1.2 Multilingual Corpus Cloning Process

To this point the assumption is that the source corpus 20 that has been modeled is largely monolingual. In the next phase, an intelligent web agent IA commonly is deployed on the Internet or in other document repositories 30 to search for target documents 109 which, in this case, are foreign language documents. Multilingual corpus cloning, generally indicated by the numeral 200 in the figures, is a process whereby source language documents 108 in the modeled corpus 40 are replicated multilingually using methods based in modern computational corpus linguistics, particularly the so-called comparable context method. Of course, any existing translations of documents within the original intranet-bound corpus 20 are located, if they exist, but most often corpus cloning will proceed by employing external document repository searching. Foreign language documents 109 are retrieved and annexed to the original corpus 20 if they are determined to be within the same domain space as the modeled monolingual corpus 40, or if they fall within the compass of the document types in that corpus 40. Once retrieved and annexed, they are themselves modeled with reference to document structure and domain to reveal any culture-bound differences in structure and domain/concept organization.

1.2.1 Multilingual Cloning of the Original, Monolingual Corpus Domain Model

The cloning process 400 (FIG. 10) begins by using the corpus domain model discovered by term and collocation parsing 105 of the original and enhanced monolingual corpora 20, 40 to construct a comparable corpus L2 430. Comparable corpus L2 430 is a set of documents in a foreign language that are not translations of a source language corpus L1 (a parallel corpus), but are in the same domain. Existing approaches to the automatic extraction of multilingual terminology from a multilingual document corpus depend on translation alignment of the translation units (typically sentences) between the corpora. This is only possible in corpora that are translations of one another, so-called parallel corpora. Such corpora are not common and only exist as the output of human translation activity. In contrast, the present invention is an approach to the automatic determination of multilingual terminology equivalents for an existing source language set that does not depend on aligned parallel corpora.

The special vocabulary (terminology) extracted during the construction of the largely monolingual corpus domain model 103 during intelligent corpus building 200 is used as the basis for building the comparable L2 corpus 430. The significant source language terms (1 word), phrases and collocations identified in the monolingual phase of corpus building are used to bootstrap the search for foreign language documents falling within the same domain as the original documents.

In the first stage 410 of the cloning process, a general language bilingual machine dictionary 411 for each of the target language of the replication process is used to lexically translate as many of the words 412 in these term-collocation sets as possible. Combinations of translated words 412 and phrases are then used as a search strategy for the intelligent agent IA to search and retrieve documents 109 where there is a significant co-presence of the lexically translated target language words 414. Significant co-presence is based on statistical assessment of the probability that sets of co-occurring words within comparable L2 corpus represent lexically equivalent contexts for a given set of words 412.

Lexical translation of words and expressions 412 does not yield actual translation equivalents. The use of lexical translations in the technique described here is to provide a bootstrapping technique to start a search for domain-equivalent target language documents.

The accuracy of the search process can be enhanced in several ways. Since the domain or domains to be searched is known as the result of the analysis of the source language corpus 20, the system can be seeded with L2 terms 414 derived from an existing machine-readable bilingual terminology 411. This has the advantage of greater accuracy in target document retrieval. Similarly, a select set of terminologically “dense” L2 texts in the proper domain can be analyzed, as by term and collocation parsing methods 105, described earlier, and the resulting set of terms and expressions 414 can be used as the search strategy for retrieving further target language documents. This also has the advantage of improving accuracy of retrieval. Finally, if parallel documents (documents that are translations of one another) are found or are available they can be used to provide an initial set of L2 terms for bootstrapping the multilingual search.

The procedure described here will operate without using standard terminologies or seed documents. Such stand-alone operation would be required in situations where a domain and its representative documents are relatively new and standard terminology glossaries or seed texts are not yet available.

The originally monolingual corpus 20 is partitioned as multilingual candidate documents are discovered and retrieved by the agent IA. The original source language corpus 20 becomes the primary partition and the multilingual documents 109 added by the cloning process compose new secondary partitions 430, one new partition for each language added. As the number of candidate documents 109 added to secondary multilingual partitions rises, the partition can be analyzed in the same fashion as described earlier (term and collocation parsing) 105, resulting in a set of comparable terms and collocations 420. This is referred to as multilingual partition modeling.

At the conclusion of the partition modeling there are two term/collocation sets 412, 414, one for the L1 (412) and one for the L2 (414). These two sets 412, 414 can be compared and the collocations in the L2 ranked as to the probability that they are candidate translation equivalents for collocations in the L1. Candidacy can be further validated by human review HR, against parallel corpora, or against standard terminologies. In general the process of the present invention will generate candidate equivalencies 415 which may be validated continuously during the operation of the translation or authoring context in which the candidates are used.

In a like manner, the intelligent agent IA would refresh its search parameters P by using those contexts with the highest probability of equivalence, to ensure that the agent IA becomes more intelligent in its cloning behavior as the size of the multilingual portion of the corpus 40 increases. To accommodate this, the process would incorporate iterative modeling of the multilingual partition as it is being constructed and improving confidence in the equivalencies identified by purely automatic means.

1.2.2 Multilingual Cloning Of The Original, Monolingual Corpus Structure Model

It has long been a staple principle of translation studies that document or textual structure is culturally bound. The corpus document structure model determined for the original, monolingual corpus 20 is valid only for the culture that produced the documents on which it was based. To produce models of document structure valid for other cultures, the original monolingual corpus document structure model 104 must be multi-culturally replicated.

While the multilingual replication of the original corpus domain model 104 (1.2.1) required the generation of search parameters PDto allow an intelligent agent IA to find and retrieve an initial set of second language L2 documents from the Internet or other document repository 30. A similar bootstrapping problem does not exist with respect to the multilingual cloning of the corpus document structure model 104 since the replication of the corpus domain model has de facto created an initial L2 document set 320. Thus, domain modeling 103 is preferably done first, and then followed by document structure modeling 104. In this way, the set of L2 documents, collectively the L2 corpus 430, generated by domain modeling 103 may be used as the catalyst for beginning the multilingual replication 400 of the corpus document structure model 104. The initial L2 document set would be analyzed as described earlier (1.1.3) and document logical structure and physical layout 102 determined.

Although there is no bootstrapping problem in this phase of cloning, as there is in the multilingual replication of the domain model 103, there is a problem of isomorphism. In the case of the replication of the corpus domain model, a primary objective of the process is the construction of an L2 document set 420 containing terms and collocations communicatively equivalent to those in the L1 set 412, e.g., for each set of terms and collocations generated for the L1 corpus, the objective is to generate at least one or more potentially valid equivalent candidate sets 420 in the L2. The replicated set 420 is roughly isomorphic with the original in terms of size and domain scope.

Using the L2 corpus 430 generated by the cloning of the corpus domain model 103 does not guarantee that a corpus document structure model 104 isomorphic to that generated for the L1 corpus 20 can be replicated. There is no guarantee that the bootstrap corpus contains a range of document types equivalent to that of the original monolingual corpus structure model even if it covers the same domains.

The problem of isomorphism will require searching for L2 documents partially matching key diagnostic criteria for document classes discovered during the construction of the L1 document structure model 104. Once the initial L1 document structure model 104 has been determined key indicators can be extracted and used in the development of a cloning heuristic. For instance, once it has been determined that one of the diagnostic properties of document class memorandum is the appearance of standard text segments (TO, FROM, DATE, SUBJECT), a document layout heuristic can be used to search for L2 documents having linguistically equivalent indicators. Documents retrieved can be validated against other L1 document-derived heuristics (e.g., patterns of length, terminological density, appearance of expected standard collocations and other indicators as described in 1.1.3). Documents whose diagnostic criteria most closely match across languages will be assumed to belong to equivalent document classes.

1.3 Artificial Corpus Mining

A process closely related to corpus mining 500, text mining, is about looking for patterns in natural language text, and may be defined as the process of analyzing a body of texts to extract information from them for particular purposes. Text mining is usually considered a form of “unstructured data mining” because the texts to be mined are typically formally unstructured as regards to information content, though they may be marked-up or otherwise structured for purposes of publication, presentation, or display. The structuring of most document corpora is primarily to serve the purposes of specifying physical layout for publishing and display. Exceptions include markup primarily for the purpose of indicating keywords and index terms.

Within the scope of the invention, artificial corpus mining or unicorpus mining 500 is more similar to structured data mining. The process of creating the artificially enhanced corpus 40 (and the concomitant creation of the corpus domain model 103 and the corpus document structure model 104) involve parsing and then “tagging” any discovered structures, e.g., terms, multi-word terms, collocations, standard phrases, logical document elements, and so on, using tags associated with appropriate metadata schemas. As the artificial corpus 40 accretes during the corpus building 300 and corpus cloning 400 activities, all documents that are added, and the elements discovered within them, are analyzed, categorized and tagged in relation to these schemas, collectively parsing 510. The parsing process 510 converts an unstructured body of data into a structured body 515.

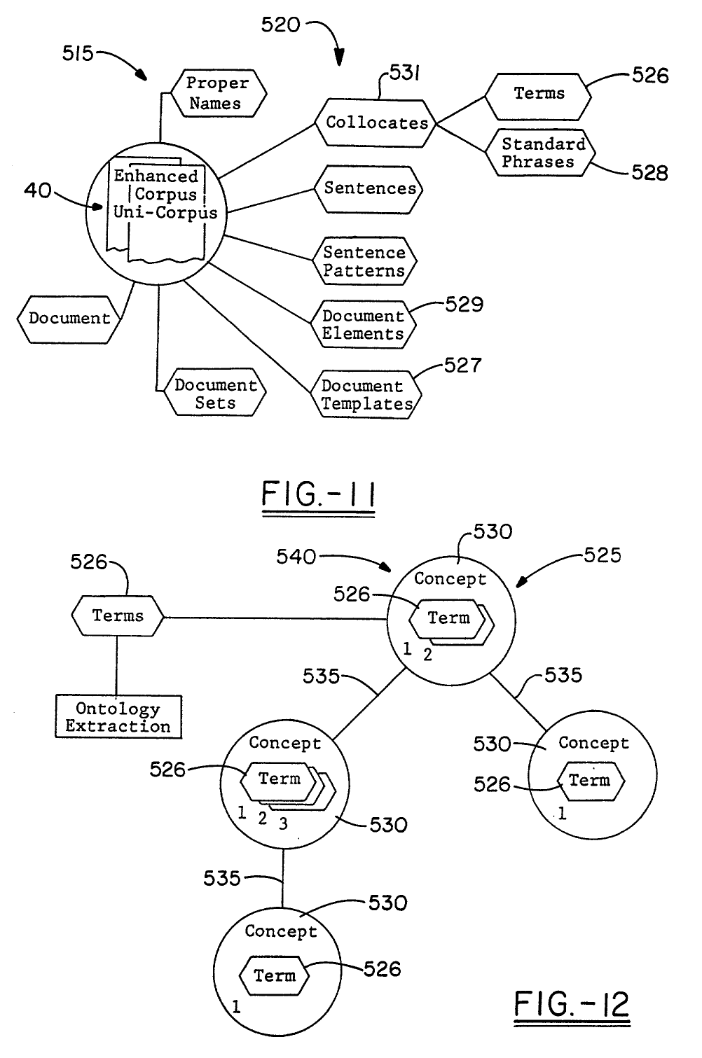

The creation of an artificially enhanced corpus 40 with multilingual partitions followed by analysis and tagging, allows for the subsequent identification and extraction (mining) of objects of value in computer-assisted translation, localization, and authoring. Some extractable objects 520 include proper names, collocates (terms, standard phrases), sentences, document elements, and documents (FIG. 11).

The objects 520 extracted from the artificially enhanced corpus 40 may be treated as simple objects. Others can be grouped into more complex composite objects 525. For instance, terms are simple objects, linguistic labels referring to the same concept in a scientific or technical domain. Terms 526 can be grouped in a composite object 525 called a concept object 530 (FIG. 6) and individual concept objects 530 may be further organized into a network 535 of related concepts and bundled together in a larger composite as a concept-oriented glossary (sometimes referred to as a thesaurus). In the context of this invention a concept object, as schematically depicted in FIG. 12 is an XML structure that includes, within it, elements that indicate multilingual equivalents, definitions, context examples, source citations, and other terminologically useful information, such as that indicated in ISO 12200 and 12620. Similarly, the statistical analysis of documents determined by domain structure modeling to be in the same document class can be used to yield a document template object 527—a more complex object yielded from the analysis of simpler ones.

Of the simple and complex objects that can be extracted from artificially enhanced corpora 40, the following are the most significant and have the greatest influence on cost reduction and profitability in computer-assisted translation, localization and authoring.

1.3.1 Multilingual Glossaries

From a properly constructed unicorpus 40 with multilingual partitions it is possible to build multilingual concept-oriented translation glossaries that can be stored as computer databases DB. These databases DB can be used in computer-assisted translation workstations LTW to increase the accuracy and speed of translation and localization. We can refer to these glossaries as terminology databases. Such databases DB can also serve as components of computer-assisted authoring and machine translation systems. Translation-oriented glossaries are complex composite objects 535 that aggregate equivalent L1 terms (synonyms) and translation equivalent L2 terms in concept objects 530 and then arrange the concept objects 530 in a semantic network 540 FIG. 6. Concept objects 530 may also include data elements other than terms 526. A number of additional data elements, as defined by ISO standards 12200 and 12620, incorporated herein by reference, may be included in such objects 535. These data elements include definitions, context/usage examples, grammatical information, register data, etc.

The method described here identifies and extracts terms from artificially enhanced corpora, multilingually replicates the term sets discovered, organizes equivalent L1 and L2 terms into concept objects, and adds relevant ISO 12200/12620 data elements, where they can be determined from the corpus, to the concept objects. Examples of data elements automatically extractable from the corpus 40 include sources, definitive contexts, pointers to contexts and usages from the extracted documents, and so on. Semantic analysis of the term sets using the principles described earlier can establish concept relationships (thesaurus relations) and organize the concept objects 530 into semantic nets or hierarchies 540.

1.3.2. Concept Networks

As discussed in the previous section, the specialized vocabulary or terminology extracted to build terminology databases can be linked in semantic concept networks 540 that represent the relationships of the concepts 530 underlying the terminology 525 (FIG. 12).

Concept networks 540 can be used in a variety of ways to enhance the speed and accuracy of translation and localization. A primary obstacle in specialized translation involves the comprehension of source text material. For the most part professional translators and localizers are not specialists in the areas in which they translate. A significant portion of the translation task is sheer research with the objective of developing a comprehension of the source material. To the extent that technical terms can be placed into semantic relationship with one another, e.g., a constructed thesaurus, the ability of the translator to understand his or her source material is enhanced. Using concept visualization techniques, the domain of a particular translation task and the hierarchic arrangements of its concepts 530 can be displayed visually and browsed conceptually. Multiple hierarchies may be discovered and captured by tagging concept relations 535 via the tags defined in ISO 12200 and 12620.

The utility of concept networks 540 is not restricted to computer-assisted translation or authoring. Since the constituent objects 520 of concept networks 540 are concept objects 530 that have aggregated all the linguistic labels (terms) 526 that refer to the concept, they may be used as a means to improve searching techniques, particularly in cross-language information retrieval. Therefore, unicorpus mining facilitates the performance of a number of tasks, generally indicated by the numeral 575 in FIG. 3, including automatic localization, authoring, content-based searching, corpus-based machine translation, document and content management, and translation.

Although tools for improving the ability of translators and localizers to comprehend the subject matter of technical and scientific domains have been described, no commercial computer-assisted translation tool has fully exploited the possibilities presented by concept network identification and extraction 500.

1.3.3. Collocation, Phrase and Sentence Collections

Phrase and sentence collections are phrases, clauses and sentences that occur in great frequency in certain text types on specific domains. Multiple word terms are a special kind of collocation. Here we consider other kinds of collocations.

To the extent that certain phrases, clauses and sentences are required in documents (for instance, legal language), can be controlled (preferred language, standardized language 528) and their multilingual equivalents specified, they are a candidate for language engineering in internationalization. The method 10 described here provides a mechanism for identifying, tagging and extracting collocations 331. The stored collocations 531 may then be used to standardize written expression, in document quality control initiatives and, generally, to improve the readability, accuracy and translatability of electronic documents.

The multilingual replication processes described earlier can be adapted to automatically identify candidate translations for phrases and non-terminological collocates. These candidate translations can be used to supplement translation memories and, more significantly to pre-populate those memories with candidate translations.

1.3.4. Document Templates

Analysis of the document set in the artificially enhanced corpus can yield sets of typical or preferred document structures. These patterns of structures can be abstracted into templates for authoring and localization. Identification of such structures can be used to assist or enforce organizational standardization—standard document structures for particular purposes. Decomposition of standard structures can yield sets of standard document elements 529 that can be stored and retrieved as an assistance in authoring and translation. The identification of communicative equivalence relationships between document templates 527 in the multilingual partitions also makes it possible to provide translation assistance by offering translators and localizers advice on the cross-cultural modifications that need to be made to document structure. Localization becomes easier and more effective, since content is being delivered in formats expected and preferred by foreign language viewers and readers.

A fully structured unicorpus 40 of an optimum size and with appropriate multilingual partitions includes all of the information necessary for reformatting documents automatically. The terminology, collocation sets, phrases, translations, and stored cross-cultural document structuring and formatting information for the range of “locales” included in the corpus-building process 300 allows adoption of a new strategy for electronic document delivery where (1) a user sets preferences in browser, reader, email client or other client application that handles documents (cultural profile), (2) then a document server 560 compliant with the process described in this invention reads the settings and selects document content, layout, organization and other document elements from an engineered corpus, and (3) the client application constructs the requested document 545 “on demand.” This approach may be deemed a client-side socio-cultural style-sheet method 550 (FIG. 13).

1.4. Corpus-based Computer Assisted Translation and Authoring

The strategies listed above create a unified multilingual corpus (unicorpus) 40 from which multilingual glossaries, concept networks 540, translation alignments, document structures and other useful objects 520 may be extracted. Each of these extracted elements can be implemented to improve the current generation of authoring and translation workstations LTW. As the process described here is applied by an organization, a feedback loop from authoring and translation systems (assuming negligible domain expansion and document type proliferation) will produce a corpus optimization curve—that is, the levels of automation in authoring and translation of documents in the corpus 40 will rise while the amount of required human intervention will fall. Attendant to these changes, costs will fall and profitability will rise. The precondition is, of course, the proper engineering of the corpus 40 using the principles described above.

1.5 Peer-to-Peer Unicorpus Resource Network

The unified multilingual corpora 40 created by the global documentation method may be hosted in a tagged database, such as, an XML-enabled database or other XML store 610 on a local server 615 or client workstation 620. This store 610 can be linked to others via a peer-to-peer application platform, generally 600, and queries for particular content can be made of the other unicorpora 40 in the peer network 600.

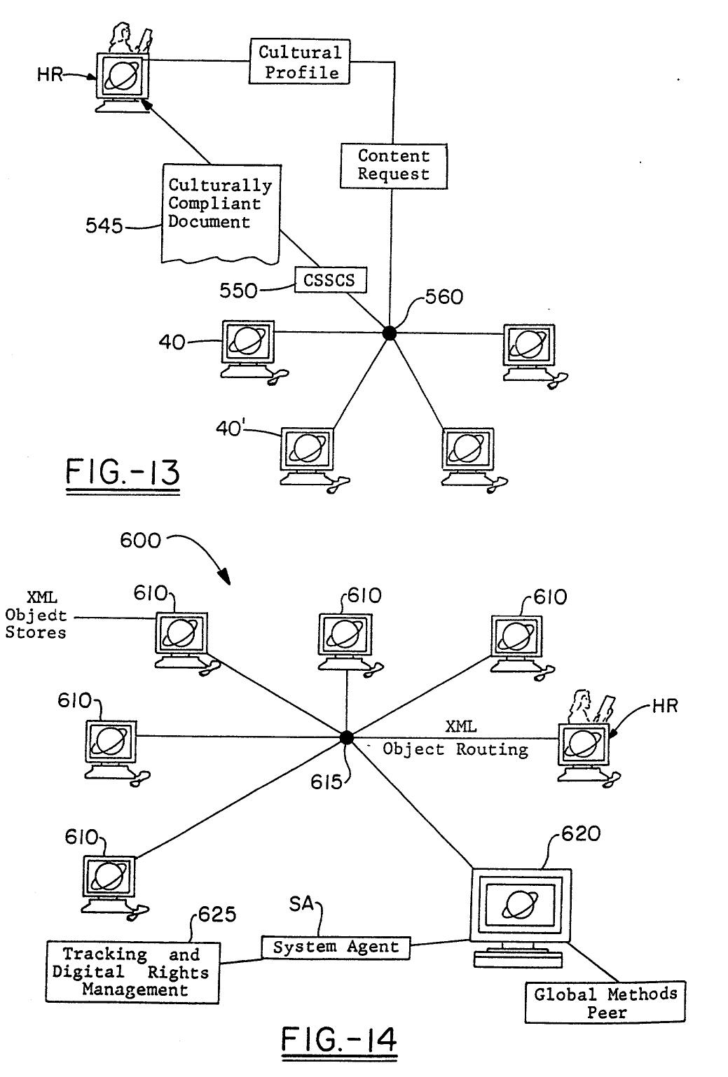

A security and digital rights management layer 625 in the peer-to-peer network 600 can be used to track transactions involving objects from the XML data stores created by the processes just described. A system agent SA can act as a collection agent and can be the basis for assessing per transaction charges for access to XML data stores created by the corpus enhancement method just described. Profit-sharing arrangements with owners of data stores created by corpus enhancement process can motivate participation in the resource-sharing network (FIG. 14).

What is claimed:

1. A method of document management utilizing document corpora comprising:
gathering a source corpus of documents in electronic form;
modeling the source corpus in terms of document and domain structure information to identify corpus enhancement parameters;
using a metalanguage to electronically tag the source corpus;
programming the corpus enhancement parameters into an intelligent agent;
and using the intelligent agent to search external repositories to find similar terms and structures, and return them to the source corpora, whereby the source corpus is enhanced to form a unicorpus.

2. The method of claim 1, further comprising replicating the unicorpus in at least one language other than the language of the unicorpus.

3. The method of claim 2, wherein unicorpus replication includes translating terms in the unicorpus with a machine dictionary.

4. The method of claim 3, wherein unicorpus replication further comprises performing an analysis of terms surrounding an undefined term to translate the undefined term.

5. The method of claim 4, wherein the analysis includes performing a natural language analysis.

6. The method of claim 4, wherein the analysis includes a statistical analysis.

7. The method of claim 6, further comprising mining the unicorpus, wherein mining includes locating tagged objects within the unicorpus.

8. The method of claim 5, wherein mining of the unicorpus includes extraction of concept systems.

9. The method of claim 7, wherein the extraction of concept systems includes determining semantic relations between individual concepts.

10. The method of claim 5, further comprising replicating the unicorpus in at least one other language to form a second unicorpus, wherein the second unicorpus is mined to obtain useful objects in the other language.

11. The method of claims 5 or 10, wherein the mining is performed selectively to assist in a task.

12. The method of claim 11, wherein said task includes authoring a document.

13. The method of claim 11, wherein said task includes content based searching.

14. The method of claim 11, wherein said task includes document management.

15. The method of claim 11, wherein said task includes content management.

16. The method of claim 11, wherein said task includes translation.

17. The method of claim 16, wherein said translation includes corpus based machine translation.

18. The method of claim 1, further comprising providing access to the unicorpus over a peer-to-peer network.

19. The method of claim 18, wherein at least two unicorpora are connected via the peer-to-peer network, such that sharing of resources occurs between the unicorpora.

20. A global documentation method comprising:
modeling a source corpus to determine search parameters;
providing the search parameters to an intelligent agent;
enhancing the source corpus by accessing resources outside of the source corpus with the intelligent agent, where said intelligent tags the modeled source corpus and retrieves resources according to the search parameters to create a first unicorpus of tagged documents;
replicating the first unicorpus in at least one other language to form a second unicorpus; and
selectively mining at least one unicorpus to perform a selected task.

21. The method of claim 20, further comprising providing access to the unicorpus via a shared network.

22. The method of claim 21, wherein said shared network is a peer-to-peer network.

23. The method of claim 21, further comprising routing documents between unicorpora connected on the peer-to-peer network to a user.

24. The method of claim 23, further comprising tracking the routing of the documents.

25. The method of claim 24, further comprising managing rights to the documents routed across the peer-to-peer network.

26. The method of claim 20, wherein the first unicorpus has a plurality of terms wherein replicating includes prepopulating the second unicorpus by using machine translations of at least a portion of said first unicorpus terms.

27. The method of claim 26, wherein prepopulating further comprises analyzing the machine translated terms to define remaining terms in the first unicorpus.

28. The method of claim 27, wherein analyzing includes a statistical analysis of terms adjacent to the untranslated terms.

29. The method of claim 27, wherein analyzing includes performing a natural language analysis of the first unicorpus terms.

30. A document management method comprising:
constructing models of a source corpus of documents;
deriving parameters from said models for the operation of an intelligent agent over at least one external document repository;
enhancing the source corpus of documents by adding selected documents retrieved by the intelligent agent to form an artificially enhanced corpus.

31. The method of claim 30, further comprising analyzing the artificially enhanced corpus to discover objects useful for at least one task;
tagging the objects within the artificially enhanced corpus to allow for identification, description, and retrieval of the objects.

32. The method of claim 30, further comprising replicating the artificially enhanced corpus in a second language.

33. The method of claim 32, further comprising performing cross-linguistic alignment of the second language artificially enhanced corpus and the first artificially enhanced corpus and tagging objects within the corpora according to the alignment.

34. The method of claim 33, further comprising prepopulating terminology management and translation memory management components of a computer-assisted translation workstation with the objects tagged in the second language artificially enhanced corpus.

35. The method of claim 30, further comprising linking the artificially enhanced corpora to at least one other artificially enhanced corpus using a peer-to-peer network.

36. The method of claim 35, wherein the intelligent agent adds documents to the artificially enhanced corpus from another artificially enhanced corpus located on the peer-to-peer network.

37. The method of claim 30, wherein the external document repository includes the internet.

38. The method of claim 30, wherein the external document repository includes other corpora resident on a peer-to-peer network.

39. The method of claim 30, further comprising analyzing the artificially enhanced corpus to discover objects useful for at least one task;
tagging the objects within the artificially enhanced corpus to allow for identification, description, and retrieval of the objects.

40. The method of claim 30, further comprising replicating the artificially enhanced corpus in a second language.

41. The method of claim 32, further comprising performing cross-linguistic alignment of the second language artificially enhanced corpus and the first artificially enhanced corpus and tagging objects within the corpora according to the alignment.

42. The method of claim 33, further comprising prepopulating terminology management and translation memory management components of a computer-assisted translation workstation with the objects tagged in the second language artificially enhanced corpus.

43. The method of claim 30, further comprising linking the artificially enhanced corpora to at least one other artificially enhanced corpus using a peer-to-peer architecture.

44. The method of claim 35, wherein the intelligent agent adds documents to the artificially enhanced corpus from another artificially enhanced corpus located on the peer-to-peer network.

45. The method of claim 30, wherein the external document repository includes the internet.

46. The method of claim 30, wherein the external document repository includes other corpora resident on a peer-to-peer network.

47. A document management system operating according to a business method comprising:
providing document management services including translation and authoring services over a global information network to a customer, where the customer has a source corpus of documents to be managed;
accessing the source corpus with an intelligent agent to analyze the source corpus, identify selected objects within the source corpus, and tag the selected objects with a metatag, wherein the analysis results in the generation of document parameters programmed into the intelligent agent for searching of external document repositories, wherein said intelligent agent uses said parameters to identify and tag objects of interest in said external document repositories and selectively retrieve the objects to enhance the source corpus; and
tracking rights in said retrieved objects to determine a royalty payable to an owner of the rights.

48. A document management system, in which a document manager is linked to a plurality of unicorpora via a peer-to-peer network, the document management system including a method of providing document management services including authoring and translation comprising:
receiving a document management request from a unicorpora in the network;
programming an intelligent agent with a set of parameters responsive to the request;
deploying the intelligent agent to search unicorpora in the peer-to-peer network to identify objects responsive to the request; and
transmitting the objects to the requesting unicorpus by way of the peer-to-peer network.

49. The document management system of claim 48, further comprising assembling the identified objects according to the parameters into a document.

50. An intelligent agent in a document management method comprising:
a program containing parameters derived from heuristic models of a source corpus;
wherein said parameters are implemented in said program to locate and retrieve documents from external document repositories.

51. An intelligent agent used in a document management method comprising:
a program including a tagging subroutine operating under parameters, said parameters causing the program to search a corporus and directing the tagging subroutine to tag language objects within the corporus.

52. An intelligent agent for searching external corpora comprising a processor having search parameters programed to:
search external corpora according to the parameters for content, tag said content identified in the search, a selectively retrieve the content.

53. The method of claim 52, wherein the content includes document structures.

54. The intelligent agent of claim 52, wherein the content includes document models.

55. The intelligent agent of claim 52, wherein the content includes objects.

56. The intelligent agent of claim 52, wherein the content includes concepts.

57. Computer readable media tangibly embodying a program of instructions executable by a computer to perform an enhancing of a source corpus in a document management system comprising:
receiving electronic signals representing parameters including document structure and document domain information regarding the source corpus;
searching external document repositories according to the parameters to identify and tag document domain and structure information in the external document repositories according to the parameters; and
reporting the tagged information for selective retrieval of the tagged information.

58. The computer readable media of claim 47, wherein the method further comprises analyzing the tagged information to create a heuristic model defining document domain and document structure information as a second parameter; and
causing electronic signals representing the second parameter to be reported to a document management server to update said first parameters.

59. Computer readable media tangibly embodying a program of instructions executable by a computer to perform a method of managing documents in a document management system comprising:
constructing heuristic models including a domain model and a document structure model in a source corpus of documents;
using the heuristic models to derive parameters for the operation of an intelligent agent over at least one external document repository;
enhancing the source corpus of documents by adding selected documents using the intelligent agent operating under the direction of parameters derived from the heuristic models to form an artificially enhanced corpus.

60. A document management system, in which a source corpus is enhanced by the use of an intelligent agent to create an artificially enhanced corpus by a method comprising:
receiving electronic signals for representing a document from the intelligent agent, the document including domain and structure information;
performing heuristic modeling of the source corpora and the received document;
and sending electronic signals representing search parameters derived from the modeling to the intelligent agent requesting another document according to the search parameter.
